(19) United States
(12) Patent Application Publication
(10) Pub. No.: US 2005/0081154 A1
(43) Pub. Date: Apr. 14, 2005

(54) System, method and apparatus for software generated slide show

(76) Inventor: Jeff Vogel, Huntington, NY (US)

Correspondence Address: Thomas A. O'Rourke;Bodner & O'Rourke, LLP, 425 Broadhollow Road, Melville, NY, 11747, US

(21) Appl. No.: 10/684,821

(22) Filed: Oct. 14, 2003

(51) Int. Cl. G06F 3/00; G06F 17/00; G06F 17/24

(52) U.S. Cl. 715/710; 715/724; 715/723; 715/963; 715/850; 715/712; 715/804; 715/730; 715/732; 715/731; 715/530; 707/104.1; 707/7

(57) ABSTRACT

A system, method and apparatus for a software generated slide show comprising a personal organizer software programed to correspond to a plurality of individual users. The organizer having a plurality of screens through which each of the users can navigate with each of the screens having a slide show window. A first series of selected pictures can be presented for a preselected time period on each of the screens of the software program. The selected pictures can appear in the slide show window independently of the screen said user is viewing. A calendar provided by the software program can hold personal appointments, events and affairs of each of the users separately.

### FIELD OF THE INVENTION

The present invention is directed to a unique souvenir or gift item. The present invention also may be used as an improved fund-raising tool for schools and other organizations on a limited budget. As well as, in another instance, providing a unique customizable organizer.

### BACKGROUND

Most often, whether it is by yearbook committee members or school newspaper photographers, pictures are taken of various school events each year. Sporting events, community service activities, and theater productions are well documented by the schools to be used in the yearbook or school or community newspapers. Today, some schools may even upload scanned or digital photos onto the school's website. However, usually only one picture out of very many is used by the yearbook or newspaper in connection with a story. Thus, many pictures that have been taken become either filed away or thrown out, never to be seen by students, parents, or the community, who might very well enjoy seeing them.

Similarly, many individuals and families have taken numerous pictures throughout the years. Most commonly; the pictures are of vacations or celebrated events, such as birthdays and graduations. These pictures, like the school's pictures, usually get thrown out or put into a photo album. For example, a family may take a trip to Washington, D.C. and take pictures of the White House, Capital Building, Lincoln Memorial, etc. Upon returning home, the family will only look once at the pictures. Then, the pictures will be disposed of or put into an album. Thus, a one-time look at these pictures makes them a virtually worthless souvenir.

In addition, many travelers look to purchase inexpensive souvenirs from gift shops on their visits to different locations. Photographs of scenic interest are frequently popular choices. Usually, vacation-goers purchase post cards depicting one of the locale's main attractions, whether it is a famous building or a beautiful landscape. These post cards can be sent to friends that were not on the trips or who have never been to the locality. However, most times travelers keep the post card because of the picture on it. The picture reminds him or her of the location. Thus, people usually deem pictures to be valuable souvenirs of places that they visit, whether the pictures were taken by them or on a post card.

Along with keeping pictures as souvenirs of their travels, people also like to see pictures of potential vacation spots. Usually, when looking at pictures from another traveler's trips, people wish to travel to the same destinations. Similarly, people may send away to a State Park or a travel agency for photographic brochures of possible vacation spots. Thus, people wishing to travel seek out pictures of potential destinations to help them determine where their next vacation will be.

Schools are continuously searching for ways to raise funds to support programs such as sport teams, academic clubs, and music groups. Many schools raise finds by selling advertising in its paper or newsletters. Some schools have bake sales or carnivals to raise the money they need. The money generated by these events is usually only sufficient to provide, for example, new uniforms for the soccer team, while the drama club and math club go without up-to-date equipment. Also, because the funds generated are so little and the time and effort to raise the money is so great, schools may use a rotating basis for distributing funds. For example, the soccer team may only get new uniforms once every six or seven years. A rotating basis for distribution of funds may be fair, but it may lead to frustration among students, parents, and administrators, if uniforms begin looking worn or props for the drama club begin breaking.

The school also exerts a tremendous amount of effort in putting on a carnival or bake sale to raise funds. Location, volunteers, and equipment are areas that may present problems. The school is continuously in need of volunteers, because paying employees to work at these events would seriously decrease the amount of funds generated. Thus, schools need a way to raise money on a continuous basis.

Advertising is a key way for schools to raise money. Most schools sell advertising spaces, for print ads, in their yearbooks, newspapers and newsletters. However, yearbooks are an annual occurrence. Thus, schools will only charge for one advertisement, one time per year. Also, few schools have the resources to generate a daily paper. Most schools will distribute a newspaper monthly or biweekly. The payment for advertising once or twice per month will usually only cover the costs of continuing to print the newspaper. Finally, school newsletters are typically one or two pages and leave very little space for advertising. Newsletters usually contain information about an upcoming or past event. Thus, companies or businesses may be reluctant to advertise in a publication like a newsletter, which is usually read quickly and discarded.

In the same regard, local businesses around a school are usually looking to advertise to the local public. Purchasing advertising space in a regional newspaper or magazine may be too costly. Many local business have only a limited advertising budget and also attract customers from only small geographical locations. As a result, high cost advertising approaches that cover a greater area are of limited value to many local businesses. So, local businesses want an inexpensive way to advertise to the locality they serve. Also, local businesses would like to have a forum where they could notify the community about sales, discounts, and/or upcoming events. Usually, a community paper is a bi-weekly or weekly publication, and, thus, local businesses may not be able to advertise sale or events that they wish to have within one or two day's notice. They must wait until the next publication to advertise a sale. Thus, local businesses would benefit from a cheap, easily up-datable method for advertising.

Non-profit organizations encounter many of the same fund-raising problems as schools. However, non-profit organizations usually are funded primarily by donations. But, these organizations also have sponsors that advertise with them. Thus, organizations would benefit from a means to add daily advertising as a supplement to their income from donations.

A means of personal organization has become a necessity. Today, people have increasingly busy schedules, and sometimes it is difficult to remember a due date, a birthday, and doctor's appointment that happen all on the same day. Both adult and children have busy schedules. Children have to keep track of homework assignments, sporting events, school dances and meetings with friends. Adults usually have their own separate appointments to keep track of, and parents must know their own calendars and their children's. Parents usually want to know when a child's homework assignment or school project is due. Thus, there is a need for an organizational means that provides a child, adult or parent an easy way to keep track of events and such.

### SUMMARY OF THE INVENTION

The present invention is directed to a apparatus, method and system that employs software to combine the features of a personal organizer and means for interaction with a school or organization. It is additionally contemplated that the present invention could be included as a gift inside of greeting cards, a souvenir, or as give-aways for promotional affairs. The individual user, a child, adult, or parent may access his or her fully customized personal organizer. The organizer presents a main screen for easy navigation through the software. An individual user can access a personal calendar, address book, or phone book. The calendar portion allows the user to enter information directly into an image of a calendar for any month for any year. The user can enter times of appointments and commentary, such as reminders. The calendar portion also contains the present date and reminders of birthdays of friends and relatives beginning a designated time in advance. The user is provided with printing options for the day's events, month's events, week's events, and birthdays and anniversaries.

On the main screen, calender screen, address book and phone book screens may also be a slide show window. In one embodiment, the slide shows will include pictures of scenic locations, travel photos or highlights, school events and/or organizations with the community, etc. The supplier may provide these pictures to the user, or the user may upload his or her own pictures to create a slide-show. The slide-show runs continuously while the user is navigating through the organizer. The rate of change of the pictures, as well as captions on the pictures, may be fully customized by the user.

In another embodiment, the organizer software can include pre-created slide shows of different cities, states and other landmarks. For example, if someone were to purchase an organizer with slide-shows of Philadelphia on it, the slide-shows may contain pictures of the Liberty Bell, downtown Philadelphia, Temple University, etc. Alternatively, an organizer with California slide-shows may have pictures of the Golden Gate Bridge, Los Angeles, Calif. beaches, etc. Thus, the pre-created slide-shows can serve a dual purpose of acting as a souvenir to recent visitors and showing potential visitors some of the scenery they might encounter.

Additionally, in this embodiment, users may create their own slide-shows using their own scanned or digital photos. In yet another embodiment, user's may be able to upload their personal photos to a main server. By the user's designation of the photo, such as city, state, landmark, etc., the photo will be incorporated into a database. Upon updating the organizer, the user can download new slide-shows which will incorporate photos from the database, which may be personal photos by other users.

The address book and phone book portions are extremely user friendly and fully customizable. Many of the users in a school community do not have extensive experience with computers for a variety of reason and an easy to follow interface is desirable. The address book portion allows the user to create mailing labels that can be printed out. The phone book arranges input from the address book in alphabetical order. The address and phone books can hold thousands of names and addresses as necessary.

An additional feature allows the user to download information placed on the supplier's server, such as a school's server or the server of any other organization. For example, for a school, homework assignments, lunch menus, test dates, sporting events, etc., the full school calendar can be easily downloaded on the individual user's calendar. Thus, children may easily download due dates for homework assignments, test schedules, etc.

The user will also be allowed to view sponsors' advertisements. Many school parents are exhorted to support local advertisers. One approach to facilitate that support is to provide local advertisements that are customized to a particular organization by the advertiser. For example, for a prom or other dance a local florist may wish to have a special on corsages for the event. Advertisements can be in the form of banner ads on certain portions of the screen or in a separate advertising section. This section also features a place for the sponsors to make coupons available for printing by the user. These coupons and other promotions can be highly customizable. The ads can be placed on the school or other organization's server where the administrator or the advertiser can have access to the advertisements to customize the ads. The sponsors may regulate the number and dates of validity for the coupons as well as determine to whom they are available to. For example, a store may permit the user of the program to print out three coupons during a given period of time. Similarly, an coupon may be limited to only a particular class.

An administrator at the school or other authorized person is given the ability to list sponsor advertisements and coupons, school events, and websites. Websites that the administrator deems worthy because of their content for the students or their families can be available to the user on the main screen of the organizer. The user may add his or her favorite websites as well.

### BRIEF DESCRIPTION

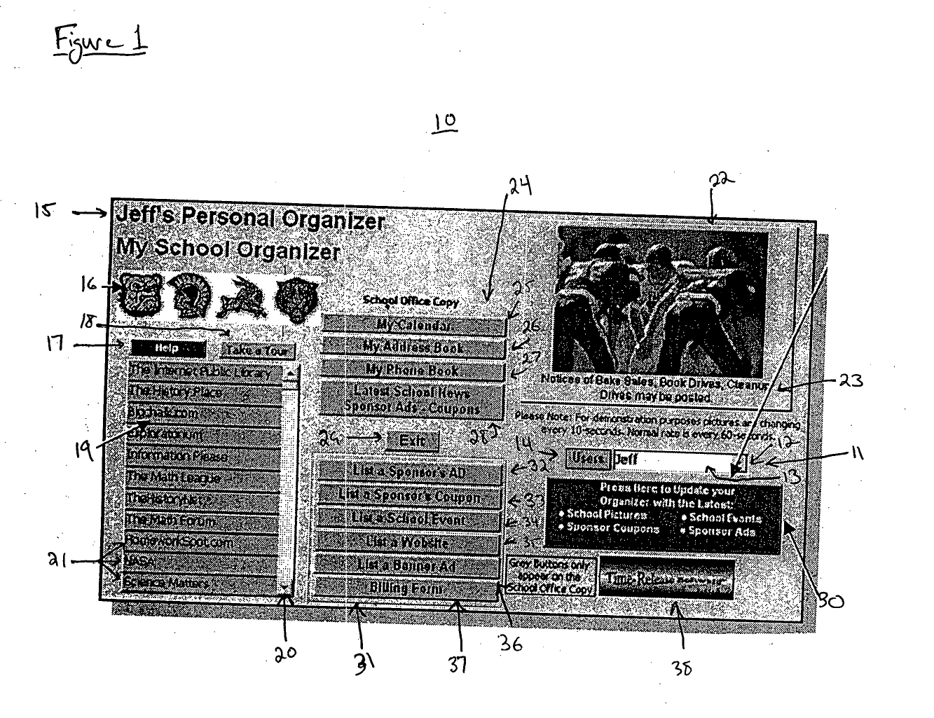

FIG. 1 is the main screen of the present invention.

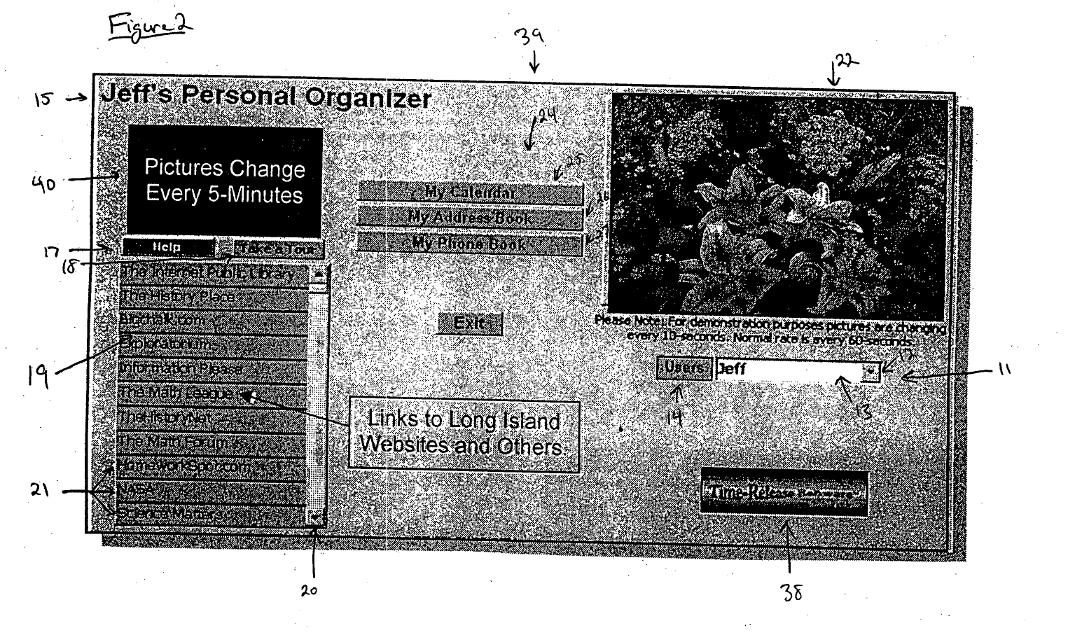

FIG. 2 is a second embodiment of the main screen of the present invention.

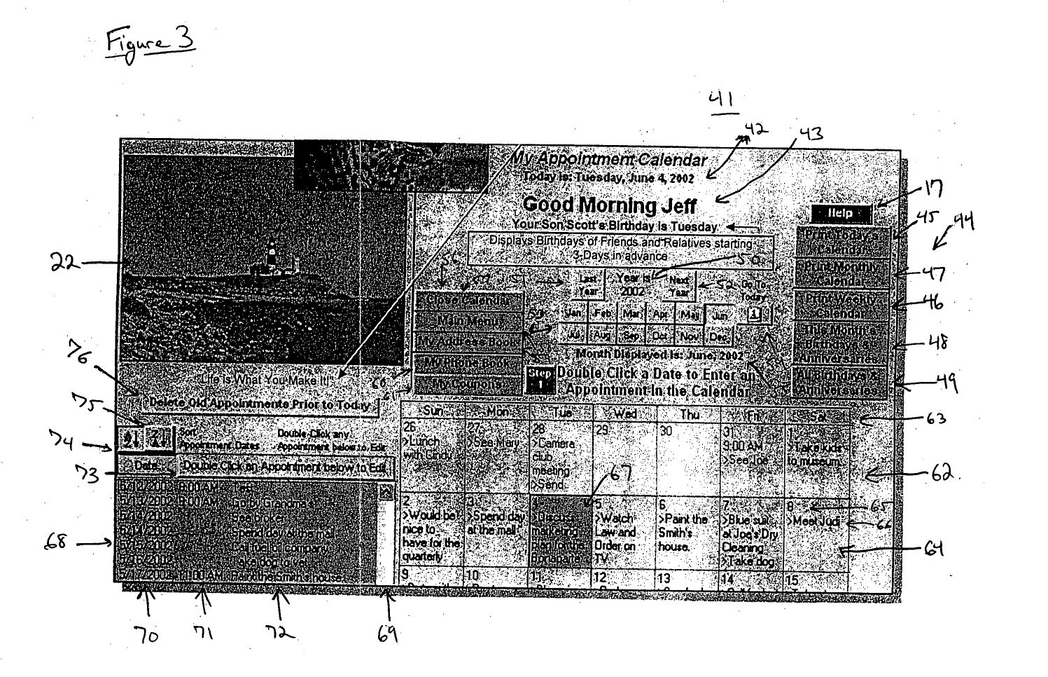

FIG. 3 is a view of the top portion of the calendar screen of the present invention.

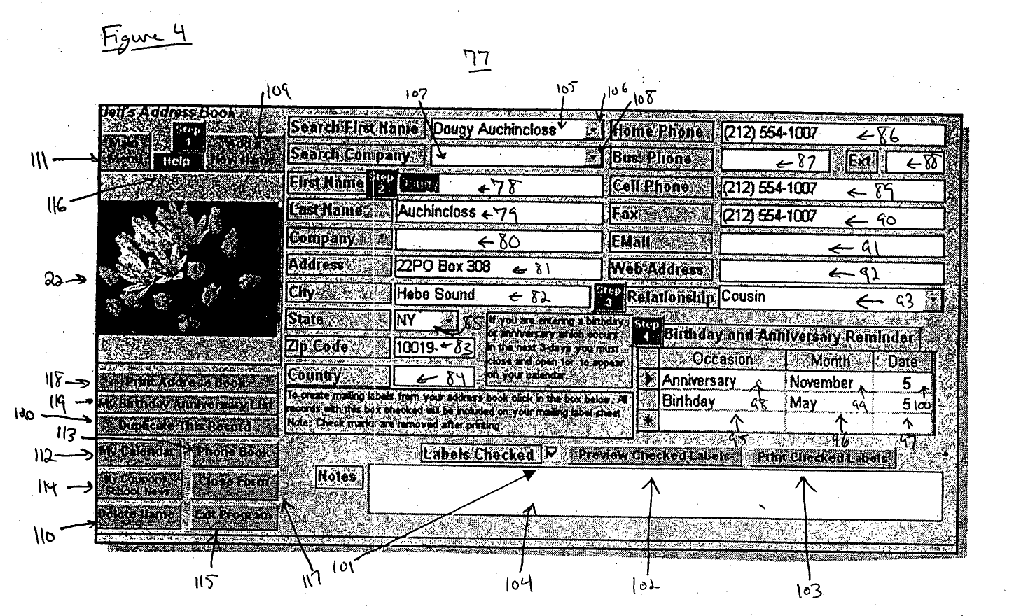

FIG. 4 is the address book screen of the present invention.

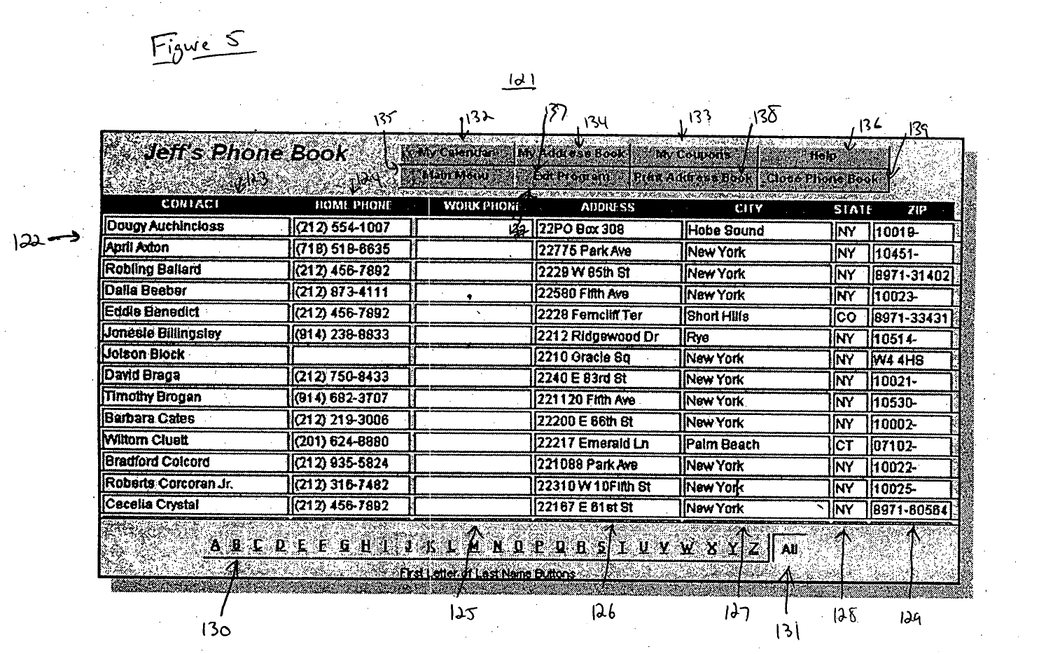

FIG. 5 is the phone book screen of the present invention.

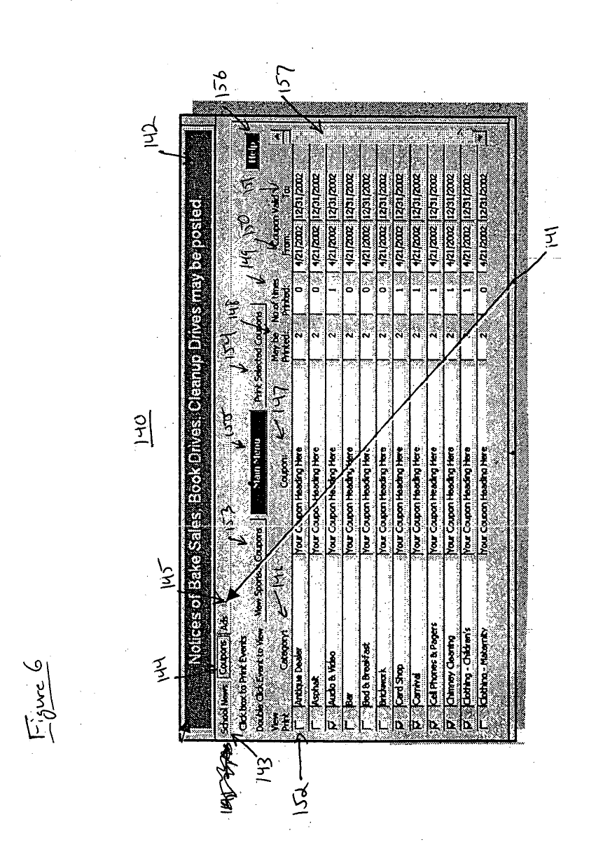

FIG. 6 is the coupons screen of the present invention.

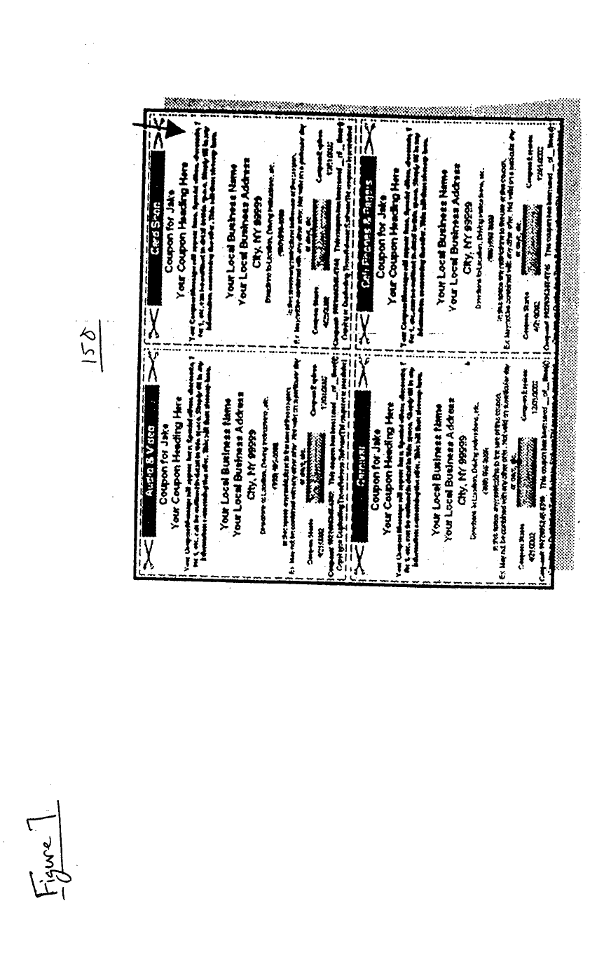

FIG. 7 is a sample printout of the coupons generated by the present invention.

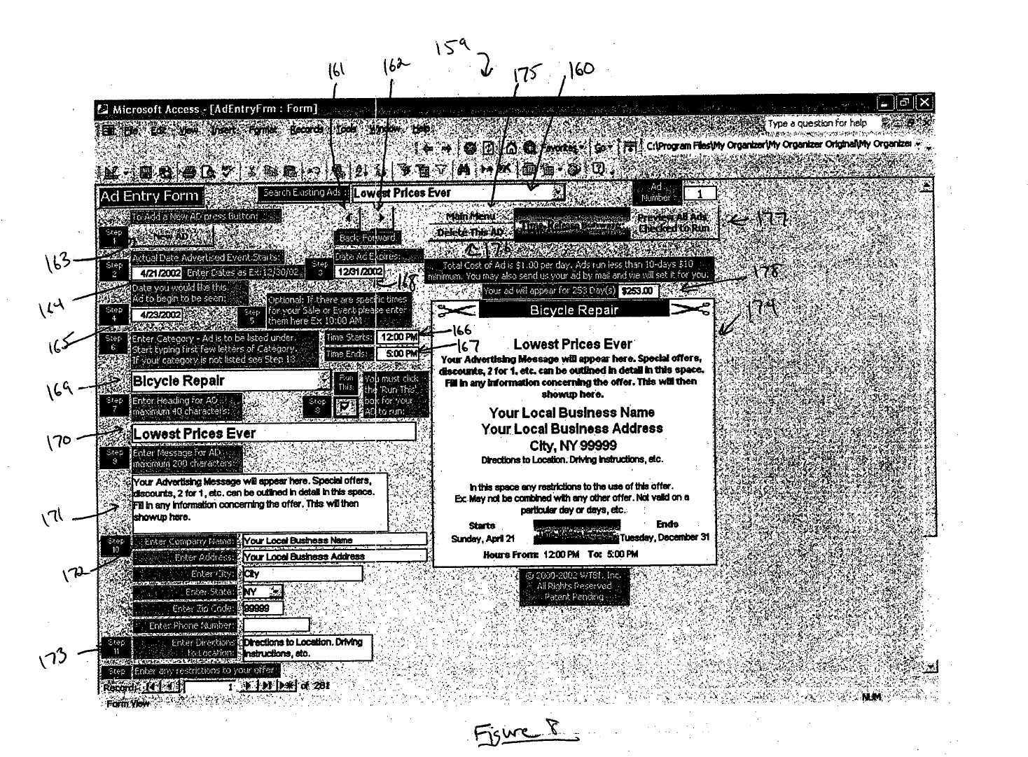

FIG. 8 is the sponsor advertisement screen of the present invention.

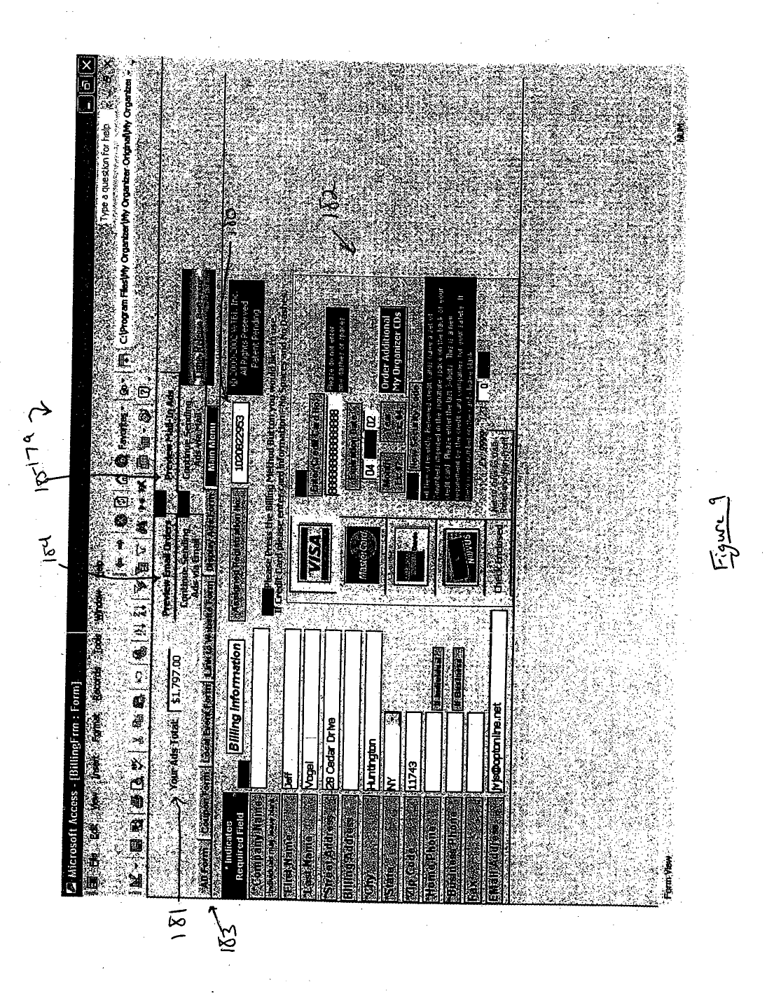

FIG. 9 is the billing form screen of the present invention.

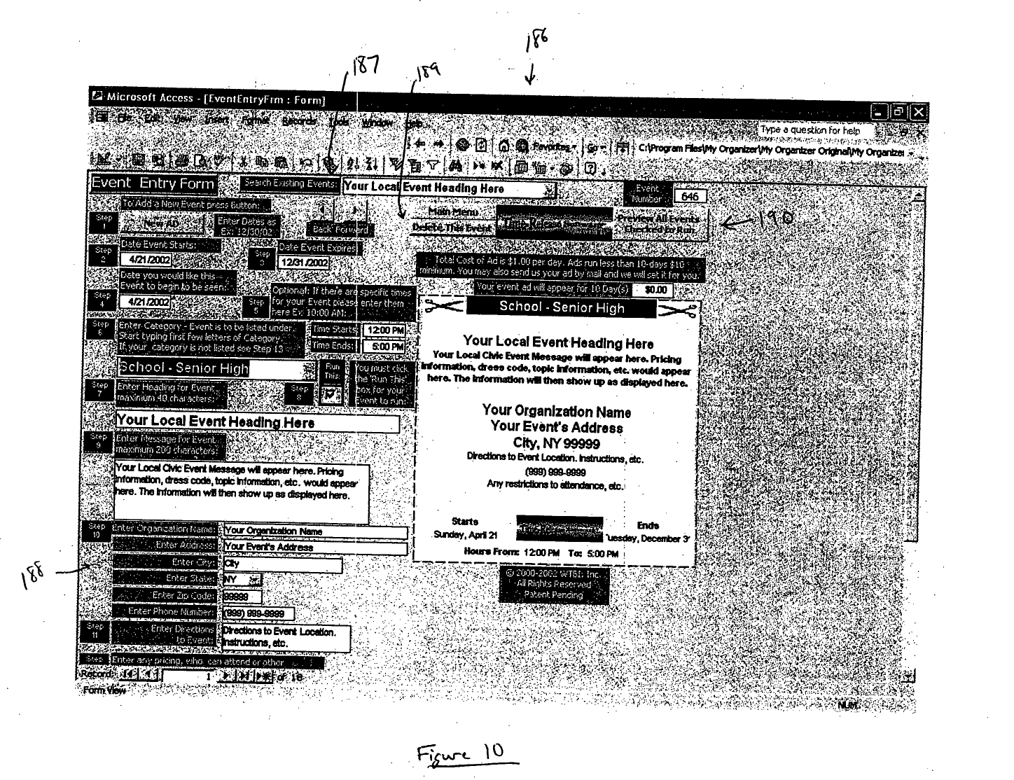

FIG. 10 is the school event screen of the present invention.

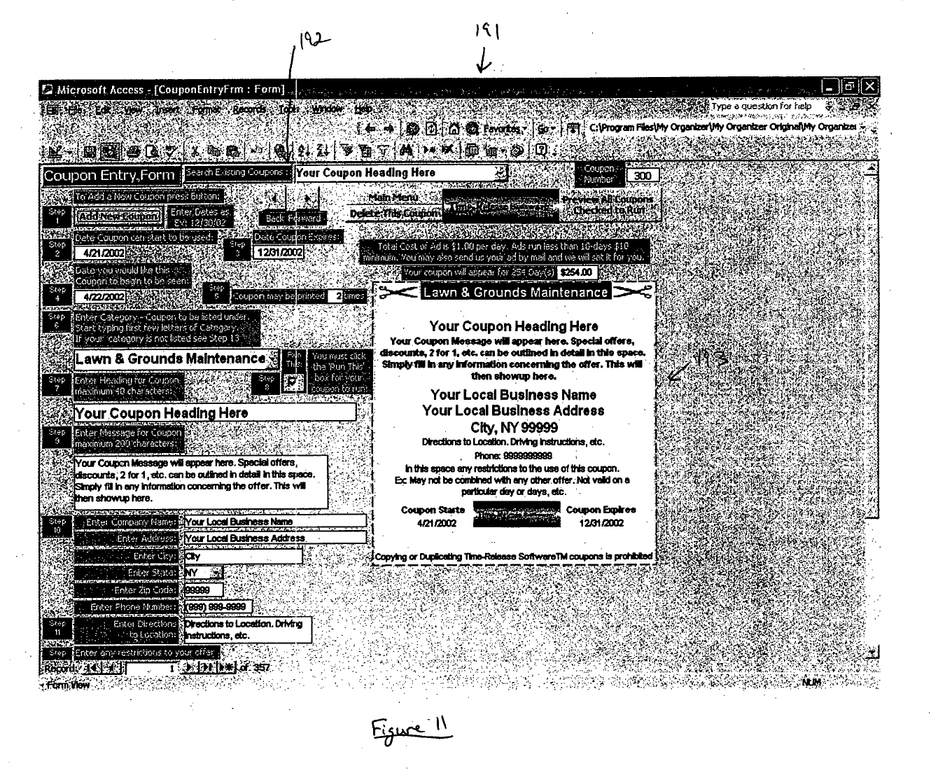

FIG. 11 is the sponsor coupon screen of the present invention.

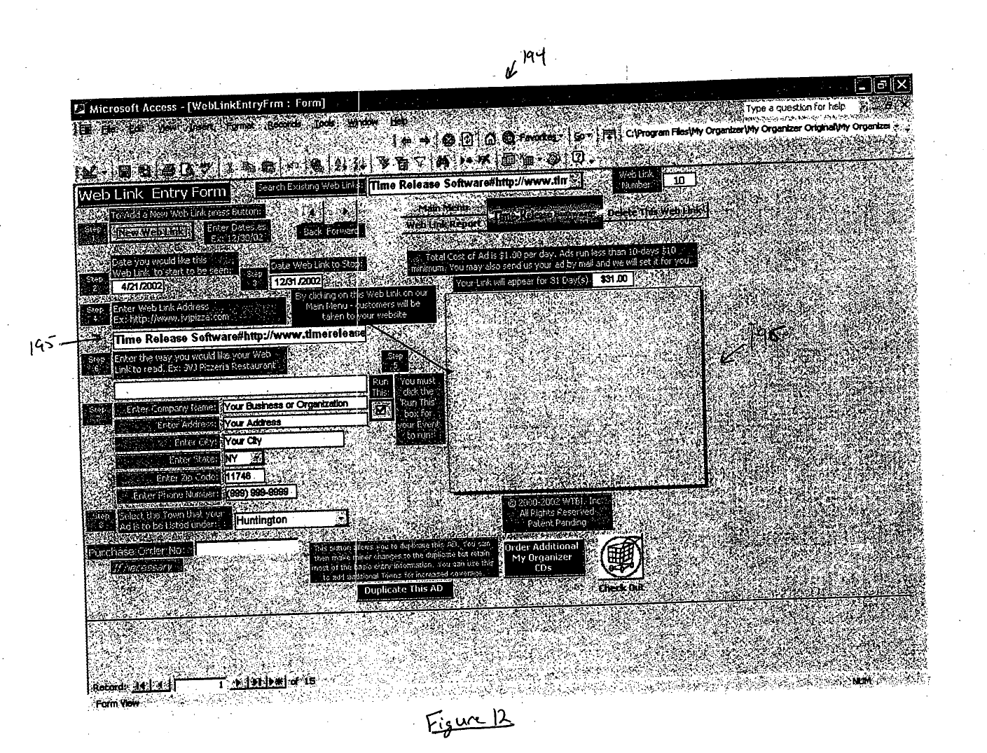

FIG. 12 is the website hyperlink screen of the present invention.

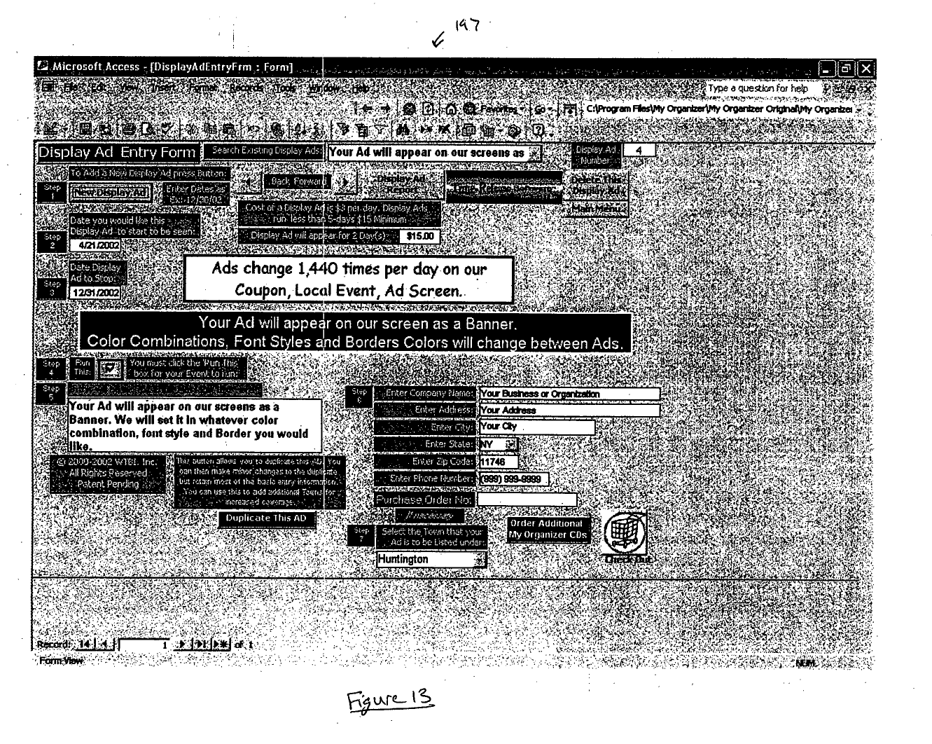

FIG. 13 is the banner advertisement screen of the present invention.

### DETAILED DESCRIPTION

As seen in FIG. 1, a representative main screen 10 is shown for navigating the invention. A user selection feature 11 allows the user to select his or her name from a list of pre-identified users. The user can select the down arrow 12, which will allow the user to browse the list of such users. Or, the user may add his name by typing an appropriate identifier for the user in the name box 13, and then press the “Users” button 14 to let the software know which personal organizer to select. The software may require a password in addition to a user name for added security.

After the user has selected his or her name from the list, that identifier can appear on the main screen 10. The title portion 15 will let the user know that he or she is working in his or her particular organizer. Underneath the title portion 15, a user may place a selected picture of the school or organization mascot 16 or other depiction. There can be a library of clip-art pictures, or the user may upload a picture of the mascot or desired picture. The picture of the mascot may be replaced with a business logo or need not be there at all.

On every screen in the software, a help button 17 is displayed. The help button 17 allows the user to access the help section of the software. Additionally, a feature of the help section may be a connection to an on-line help source to facilitate interactive or on-line help.

Adjacent to the help button 17 in this example of the main screen is an optional tutorial button 18. By accessing this feature, the user will be guided through an interactive demo version of the software introducing the user to all of its capabilities.

On the main screen 10 there may be a website list section 19. The website list section 19 can be equipped with vertical scrolling 20 and horizontal scrolling (not shown) capabilities. The websites 21 on the list can be names of websites or hyperlinks to the websites. Thus, if the user has an internet connection capability, clicking on a hyperlink may establish an internet connection and take the user to that website. The user may add or delete websites in the website list section 19 at any time; he or she does not have to be connected to the internet. Also, the user may update his or her list of websites by downloading a list of appropriate websites from the school's server. This can be done when the user updates the organizer.

One of the advantages of the present invention and an important selling feature is the ability of the program, organization and/or the user to display pictures of pertinent events at the organization so that the program is customizable for each organization. For example, the school may have a downloadable series of pictures from different activities that parents and other supporters would be interested in viewing an\s they rotate onto the screen. In one embodiment, the initial disk or other embodiment of the software is pre-laded with a plurality of pictures that the program can scroll through for the user. The program may be a source of additional revenue to the organization as the group can offer additional pictures of events on a subscription basis over time.

In another embodiment, the user may upload his or her pictures to a main server. The main server may compile the uploaded photos into slide-show sets, which can be downloaded by subsequent users. For example, the users may upload the picture under a designation, such as varsity basketball game or picture of Liberty Bell in Philadelphia. The server can then place each picture in its respective category, such as high school sports and Philadelphia, respectively.

The advantage of having the organizer pre-loaded with pictures of states, cities, landmarks, etc. is that the organizer can also serve the purpose of being a souvenir. A recent visitor to a location can recount his or her visit when using the organizer. Pre-created slide-shows with pictures of vacation sports, such as Virginia or Yellowstone National Park, will be shown while the user is accessing the organizer.

The main screen 10 has a slide-show window 22. The software has a library of slide-shows available to the user. Also, the user may create or upload his or her own slide-shows to be viewed while using the software. The user may download slide-shows or individual pictures from the school's server when the user updates the organizer. However, the school may decide to package a number of pictures and slide-shows to sell to users. The user may designate/create captions 23 for the slide show pictures, or the captions may be created by the school and come with the slide-show. However, the school may choose to put notices of school events as the captions to the pictures, or as the pictures themselves, such as a poster. The slide-show picture change rate is customizable to the point that a user may close the slide-show window if he or she chooses.

In addition to pictures of school events and organization logos or ads, another embodiment of the present invention will have software pre-loaded with pictures of geographic locations, such as states, cities, landmarks, etc. These libraries of pictures will be desirable by travelers and potential vacationers. For travelers, the library of photos can be a souvenir of their recent visit to that particular location. For example, upon departing from Florida, a visitor purchases the organizer software with pre-loaded pictures. When the user accesses the organizer at home, he or she will have a slide-show of pictures, such as an orange grove, Disney World, Orlando beaches, etc.

In yet another embodiment, the user can use scanned or digital personal photos to create a library of pictures that can be shown in the slide-show window. Thus, the user can create a customized slide-show, which is a souvenir and organizer in one software application.

The main screen 10 may also contains a set of navigation buttons 24. The navigation buttons 24 allow the user to easily operate the software. The user can press a calendar button 25 and be taken to his or her appointment calendar. The address book button 26 and phone book button 27 take the user to those respective screens. The coupons button 28 takes the user to a screen where he or she can view the latest school news, sponsor ads, and sponsor coupons. Another navigation button 29 is the exit button 29. This button allows the user to stop using the software and exit back into the main operating system of the individual's computer. Additionally, the user will be prompted if he or she would like to save all the changes that have been made. If the user answers “yes” the software will quit. If the user answers “no”, he or she will be taken back into the software to perform the appropriate save step.

The main screen 10 may contain the update button 30. If the user presses the update button 30, the user's computer tries to establish an internet connection. If the connection is unsuccessful, the user is notified. If the connection is successful, the software contacts the school's server. At this point, the user's software downloads information of the school's server, such as slide shows, websites, school events, sponsor coupons, and sponsor ads. When the information has been downloaded, the user is told that the software must be restarted for the updates to process. In another embodiment, the update button 30 will not be present. The software will be customized by the user to update at any time designated by the user. For example, a user may want to update at 3AM every day or once a week.

Also, on the main screen 10 are a set of administrator button 31. The administrator buttons 31 only appear on the software purchased by the school or organization administrators. If any businesses want to advertise on the software to users, they must contact the school first. The school administrator will take down the information from the business and create the advertisement using the sponsor advertisement button 32. After pressing the sponsor advertisement button 32, the school administrator will be taken through a series of steps that will allow him or her to create the advertisement. Various fonts and clip-art pictures will be available on the software. Also, the school administrator will be able to download logos and information off of the business's website.

In an alternative embodiment, the advertiser may upload his pre-designed advertising copy directly to the organization's server. The administrator will usually have an approval process before the uploaded information is accessed by the users. This will ensure that only appropriate information is available to the relevant community. Similarly, relevant sub-organizations affiliated with the main organization, such as the PTA can have access to the server to upload data concerning the sub-organization's activities.

In another embodiment, if the sponsor wishes to provide a printable coupon to the users, the school administrator will press the sponsor coupon button 33. This will allow the school administrator to create a text coupon that is easily printable by the user. The administrator can also regulate the number of coupons available to each user according to the wishes of the business. alternatively, the retailer can submit coupons in digital format to the server for use by the members of the organization.

In order to keep the program relevant to the users, the school administrator has the ability to list additional school events on the program. for example, by pressing the school event button 34 the server can transmit to the users an updated calendar the next time they log on. Also, if additional pertinent websites are identified compatible with the organization, a listing of the website may be made by pressing the website listing button 35. If the school administrator lists a website, that website will be placed on a list of websites available to the user upon updating. School events sponsor ads and sponsor coupons will be available to the user when he or she presses the coupon button 28.

Banner ads can be created by the school administrator by pressing the banner ad button 36. The school administrator can create the banner, use an ad provided by the retailer or download the banner from the business's website. Banner ads can be displayed on any or all screens of the software as desired by the organization. In the event one or more of the organization's members do not want to receive banner ads the administrator's server can attend to blocking those ads as necessary.

When the school administrator has finished creating the sponsor ads, coupons, and/or banners for a particular business, he or she can create a billing form by pressing the billing form button 37. Preferably, the school administrator will be able to select the business name from a list of advertisers that was previously prepared, and then, the software will import the number and duration of all of the advertisements, coupons, and banners that have been created for that business. The billing form can then be manually sent or e-mailed by the school administrator to the business. Also, a copy of the billing form should be sent to a file in the school administrator's system, which will keep track of bills and businesses.

FIG. 2 shows an example of an embodiment of a personalized main screen 39 of the present invention. The main difference between this screen and the scree of FIG. 1 is that administrator buttons are not shown since the user's screen will not permit most users to have access to these features. In this embodiment, a user can not get updated on the latest school news by pressing the coupon button 28 or other button. However, a user that does not have any concern with school matters will use this version. For example, business may be able to sell compatible software that will allow the user to get coupons from the business and a calendar of events from the business, such as training classes or dining discount nights. This information can be incorporated into the user's calendar if he or she desires. The compatible software may also contain the business's website with useful links to product lines or information on how to use the products.

Also, in FIG. 2 instead of the school mascot picture, the user may be given a picture window 40. This picture window 40 may display any picture or ads of the users choice. It can be another slide-show feature or a static image. Or, if a user buys or is given compatible software from a business, the picture window 40 may attract advertisements from the business. Or, the picture window could be used to remind the user of important appointments he or she has or updates of the software that are available.

FIG. 3 shows the top portion of the user's personal calendar screen 41. On this screen, the slide show window 22 is present, and the same slide show that was present on the main screen 10 can continue on the calendar screen 41. The calendar screen 41 has a present date display portion 42, which may also display the running time as a clock in analog or digital format. The greeting portion 43 can be changed based on time of day and user name. For example, the greeting portion may display the message, “Good Evening Jeff” at 7PM at night. Beneath the greeting portion 43 is a reminder window 44. The reminder window 44 displays birthdays of friends and relatives starting three days in advance. However, the reminder window 44 may be anywhere on the screen and will allow the user to determine the amount of time to begin displaying the reminders. Also, the user can determine what reminders will be displayed, such as birthdays, anniversaries, tests, homework, etc.

As with every other screen in the software, preferably a help button 17 is displayed. The calendar screen 41 also contains printing buttons 44. The user can print any day of the calendar by pressing the print today's calendar button 45. Also, the user can print any week or month of the calendar by pressing the print weekly calendar button 46 or print monthly calendar button 47, respectively. The user can display and print any month's birthdays and anniversaries by pressing the month's birthdays and anniversaries button 48. The user can display and print all birthdays and anniversaries, which will be obtained from the user's address book, by pressing the all birthdays and anniversaries button 49.

The calendar screen 41 has a year display 50 that tells the user what year the calendar displayed is for. The user can choose a year to view by using the year toggle buttons 51 and 52. A first year toggle button 51 allows the user to view past years, and a second year toggle button 52 allows the user to view future years. The toggle button 51 and 52 can be replaced with a pull down list of years or a user input window, where he or she can type in the year and it appears.

The user is also provided month selection buttons 53 which allow the user to view any month by pressing its respective button. If the user has been looking for in the past or future, he or she can return to the present day and month by pressing the today button 54. The user is informed as to which month and year he or she is viewing by the month display 55. The month selection button 53 may be replaced by a pull-down list or user input window.

Navigation buttons 56 are displayed on the calendar screen 41. The user may close the calendar being viewed with the close calendar button 57. The user may return to the main screen 10 by pressing the main menu button 58. Also, the user may access the additional features with the address book button 59, phone book button 60, and coupons button 61. Additionally, an exit program button may be added.

On the calendar screen 41 is a monthly calendar display 62. The monthly calendar may display a single month or more. The top row 63 of the monthly calendar display 62 lists the days of the week in a horizontal successive fashion, beginning with Sunday. The monthly calendar display 62 is comprised of cells 64 that represent numbered days within the month. The cell 64 has a day number display 65 and an appointment display 66. The program indicates the present day by a shaded cell 67. If the user wishes to alter a cell 64 in any way, he or she must “double-click” the cell 64. The user can import text and/or pictures into the cell if desired. Many appointment can be listed in a single cell 64.

Also, on the calendar screen 41, next to the monthly calendar display 62 is a text-only calendar 68. The text-only calendar extracts data from the monthly calendar display 62 and puts it in an easy to read text window. Thus, if the user has entered numerous appointments for one day and the monthly calendar display 62 does not show all of them or cuts some off due to cell space, the text-only calendar 68 has a vertical scroll bar 69. The text-only calendar 68 has a date column 70, an appointment time column 71, and an appointment description column 72. The user can edit appointments this way by “double-clicking” on the line with the date of the appointment. Or, the user can press the appointment edit button 73 to edit appointments. Pressing the appointment edit button 73 will place a highlighted line in the text-only calendar. The user can move the highlighted line up and down until the desired appointment date is reached. Any change on the text-only calendar 68 will result in a simultaneous change on the monthly calendar display 62. The user can also list the dates in the test-only calendar 68 in descending order by pressing the descending sort button 74 or ascending order with the ascending sort button 75. The user has the ability to delete all appointments prior to the present day with the delete prior appointments button 76. Additionally, the user may be given the option to clear an entire week, month, year or calendar.

The address book screen 77 is seen in FIG. 4. The user may enter a person's first name in the first name input 78. Last name in the last name input 79. A person's company can be input into the company input 80. The user provides the relevant information in the street address input 81, city input 82, zip code input 83 and country input 84. The country input 84 may be defaulted to United States or any country the user desires. The state input 85 is a pull down list, but may be replaced by a user input window. The user then enters the relevant phone numbers into the home input 86, business input 87, extension input 88, cellular input 89, and fax input 90. E-mail input 91 and web address input 92 are available for a person's e-mail address and personal/business website, respectively. A relationship input 93 is available in the form of a pull-down list. The pull-down list may be replaced by a user input. It is understood that more categories may be added while others may be removed.

The address book screen 77 contains a birthday and anniversary reminder window 94. The window contains an occasion column 95, a month column 96, and a date column 97. There are user inputs shown for each column as an occasion input 98, month input 99, and date input 100. However, these inputs may be replaced with pull-down lists. The program interprets the input and can then display reminders on the calendar screen 41.

The software is equipped with the capability to make mailing labels from data entered in the address book. If the user wishes to create a label for a person, the user can “click” in the label box 101. The user can then preview all checked labels with the preview label button 102 or print all checked labels with the print label button 103. The user may also add notes about the address book entry in the entry notes input 104.

The user is provided with the ability to search his or her address book. The user can enter a name, first or last, into the name search input 105; or, the user can use the pull-down feature 106 and search an alphabetical list of entries by last or first name. The user can also search entries by inputting a company name in the company search input 107. A pull-down feature 108 is available for the company name search as well.

When the user initially accesses the address book screen 77, a blank entry form will be available. That is, all fields will be either clear or set to their defaults. If the user is entering multiple entries, he or she can save the working entry and clear the form for a new entry by pressing the new name button 109. The program may also contain a clear entry or delete entry function with use of the delete name button 110.

Navigation buttons are provided in the form of a main menu button 111, a calendar button 112, a phone book button 113, a coupons button 114, and an exit program button 115. A help button 116 is again available to the user. The user can close the address book with the close form button 117.

The user is provided, again, with printing functions. The print address button 118 allows the user to print one, many, or all addresses that the user has entered. The user may access (view) and/or print a list of anniversaries and birthdays with the birthday print button 119. Also, the user may duplicate an entry with the duplicate entry button 120. The slide show from the main screen can again be viewed in the slide show window 22.

FIG. 5 shows the phone book screen 121 of the present invention. The phone book portion of the program is simply a display of information entered into the address book by the user. The phone book extracts several pieces of information from the address book and presents them in a concise, alphabetical phone book format. The phone book 122 is arranged into a contact column 123, a home number column 124, work number column 125, address column 126, city column 127, state column 128, and zip code column 129. The user may view entries with last names beginning with a specific letter by using the letter search button 130. Also, the user may view the entire phone book by pressing the all view button 131.

Navigation and printing buttons are available for the user. The user may access the calendar with the calendar button 132; the phone book with the phone book button 133; the address book with the address book button 134; the main menu with the main menu button 135. The help button 136 is present, as well as, the exit program button 137. The user may print a selection of phone numbers or the entire phone book with the print phone book button 138. The close phone book button 139 will return the user to the main menu.

FIG. 6 shows the coupon screen 140 of the present invention. On the coupons screen are a list of tabs 141. These tabs 141 allow the user to navigate between the school news screen (not shown), the coupons screen, and the sponsor ads screen (not shown). At all times, banner ads 142 can be displayed. The banner ads 142 can be sponsor ads or school events notices. A user not using the school organizer will not have the school events tab 143. However, all users will have the coupons tab 144 and ads tab 145.

On the coupons screen 140, sponsors' coupons are arranged. A category column 146 classifies the type of coupon. Many coupons may be placed in the same category. Category column heading may be replaced with Business name. The coupon column 147 displays the type of discount, sale, or deal being offered. A user is notified on how many coupons are available by the may be printed column 148, and on how many more coupons they have left to print by the number of times printed column 149. Coupon validity and usability can be displayed on the screen.

All of the information on these screens, coupons, school news, and ads is preferably entered by an administrator. The only user input is on the coupon screen 140 in the check boxes 152. According to the boxes that are “checked”, the user may view the selected coupons with the view coupons button 153, or print the selected coupons with the print coupons button 154.

A main menu button 155 is available for return to the main menu. Other navigation buttons may be added, such as address or phonebook. A help button 156 is available, as well. If the list of coupons is longer than one screen, the user has use vertical scrolling bar 157.

FIG. 7 shows a sample printout of coupon 158. The coupon 158 are simply text so that an administrator may create them and they are easily printable by the user.

When an administrator presses the “List a Sponsor's Ad” button 32, the sponsor advertisement screen 159, as seen in FIG. 8, will be displayed. At the top portion of the screen may be an advertisement search menu 160 which would allow the administrator or other user to search for the title of a particular ad by inputting words or using a pull down menu. A search feature is also available by use of back toggle button 161 and forward toggle button 162.

A user can follow easily the numbered steps provided on the screen to generate an advertisement to a business's or organization's preference. The new ad button 163 will present the user with a blank form. Before presenting a blank form, the user may be asked if he or she wants to save what was previously being worked on.

The user may then enter information that will be displayed on the advertisement itself. Advertisement start date entry 164 and end date entry 165 are available as customizable options of the advertisement, as well as time entries 166 and 167 and an advertisement expiration entry 168. A first seen entry may automatically enter the date from the advertisement start date entry as to have the dates be identical.

The user may then enter the text of the advertisement itself. An advertisement category entry 169 may be filled in by the user or by indicating one of the pre-existing categories from a pull-down menu. An advertisement category will allow users wanting to view the advertisements to be able to search the advertisements in an efficient manner. For example, a person wanting to look for restaurant advertisements may not want to go through the advertisements for sporting goods stores just to get to the restaurant advertisements. An advertisement heading entry 170 is also available. The advertisement heading may be how the administrator or user identifies these particular advertisements within a category.

The advertisement message entry 171 will allow the user to enter specific information about this particular advertisement, such as sales, discounts, etc. All contact information, such as business name, address and phone number for the business which is sponsoring the advertisement can be entered into the contact information entries 172. The form also has an option for the sponsor to give directions to his or her establishment in direction entry 173. The sponsor can also direct his advertisement to one or many towns with the town select entry.

As the administrator is entering the various information to create the advertisement, a sample advertisement 174 can be updating. Preferably, the sample advertisement 174 will update in a real-time fashion, or after data has been entered into each field. Alternatively, once the entire advertisement is created, the administrator may press a preview button (not shown) to see the advertisement as it will be posted.

The administrator may duplicate the advertisement with the duplicate advertisement button. The initial information will-be saved and a new advertisement entry will be created with identical information. Thus, if the sponsor wants to run an identical advertisement but with, for example, a different start/end date or discount/special, the administrator will only have to make minor changes.

The advertisement entry form includes the main menu button 175 to transport the user back to the main screen 10. An administrator may delete an advertisement with the delete advertisement button 176 and view all running advertisements or advertisements about to run (to be seen by end-users) by pressing the preview all advertisements button 177.

A price display 178 also appears on the advertisement entry form. After the administrator enters the start and end dates for the advertisement, the software internally calculates how many days the advertisement will be seen by users. The number of days is then multiplied by an administrator-determined monetary amount per advertisement, and is displayed in the price display 178.

FIG. 9 is the billing form screen 179 which appears when the administrator presses the billing form button 37 on the main screen 10. Preferably, each sponsor will be assigned a registration that will be identified when creating advertisements and used when billing. On the billing form, the administrator will only have to enter the registration number in the assigned registration number entry 180 and all of a company's organizations or individual's information, such as name, address, phone number, will be imported to there respective fields in the billing form. Additionally, the prices from all of the sponsor's advertisements will be added together and imparted to a total price display 181, which will be applied to a sponsor's bill.

The payment information entry 182 is available for the first time a sponsor is billed. Preferably, after filling in payment information a first time it will be attached to the registration number assigned to that individual, business, organization or company and will be filled in automatically for subsequent bills.

Navigation buttons 183, as well as preview buttons 184 and 185, are included on the billing form screen 179.

FIG. 10 is an embodiment of the event screen 186. The event can be any function for a school, business, organization or other group. A search entry 187 gives the administrator the option of selecting previously written event announcements, or names of businesses or organizations that have filed previous event announcements. Time, date and location of the event can be entered to customize the event posting. Sponsor information can also be filled in to demographic entries 188. The administrator can remove the posting with the delete event button 189 and preview all events with the event preview button 190.

FIG. 11 is an embodiment of the coupon screen 191, which also includes a search entry 192 for existing coupons. Sponsor information and text and/or graphics can be entered on the coupon, customizing it to each business, organization or event. The administrator can be presented with the same options that are available on the previously described screens, such as navigation, demographic information entries, deleting coupons and preview all coupons. Additionally, a real-time update window 193 can be available for viewing the format and print-previewing the coupon as information is entered.

FIG. 12 is an embodiment of the website hyperlink screen 194 provided to the administrator. A hyperlink entry 195 is provided for the administrator to enter the business's, organization's or sponsor's hyperlink to its website. A real-time update window 196 can be available for viewing the format of how the hyperlink will appear to end-users. Color, font-type and font-size can be customizable to the sponsor's desire.

FIG. 13 is an embodiment of the banner advertisement screen 197 of the present invention. The start and finish dates are adjustable as to user preference, as well as the text of the banner advertisement. The user may desire a specific format, color and font for its advertisement, or these features may vary with each posting of the banner. For example, on the main screen 10, the banner advertisement may have a thirteen point font with a blue background, but when the user advances to the address book screen 77, the font may be 16 point, with a white background. These features can be customizable.

A database screen is concurrently contemplated for use with the present invention. The database used in conjunction with the software is preferably compatible with the MS Office. Access to the database is provided by an administrator program. Within a forms sub-category, the administrator can access different functions for the organizer software. For example, the administrator create can create a slide-show archive form which will allow the user to access slide-shows that were available before the user purchased the software.

Also, the administrator may incorporate a switchboard function into the Access file. The switchboard function can allow the administrator to import email orders for new advertisement from sponsors, or export calendar, slide-show, coupon, etc. updates to a main server. Thus, when a user presses the update button, new information will be available to him or her. It is understood that the Access file is fully customizable by an administrator, and that the switchboard function is merely an example of one administrative feature.

1. A method for organizing personal affairs comprising:
initializing a personal organizer software program to correspond to a plurality of individual users, said organizer having a plurality of screens through which each of said users can navigate, each of said screens having a slide show window;
presenting a first series of selected pictures for a preselected time period on each of said screens of said software program, said pictures appearing in said slide show window, said pictures appearing independently of the screen said user is viewing; and,
arranging a calendar provided by said software program, said calendar holding personal appointments, events and affairs of each of said users separately.

2. A method according to claim 1 wherein said personal organizer software is packaged on a compact disc.

3. A method according to claim 2 wherein said compact disc can be placed in a greeting card.

4. A method according to claim 2 wherein said compact disc can be a promotional item.

5. A method according to claim 2 wherein said software program is adapted to be customizable by each of said individual users.

6. A method according to claim 1 wherein said pictures are presented on said screens in a successive sequence while said user remains on said screen.

7. A method according to claim 1 further comprising the step of said user uploading pictures a second series of pictures to replace said first series of pictures in said slide show window.

8. A method according to claim 6 wherein said pictures are pre-packaged with the software program.

9. A method according to claim 1 further comprising the step of connecting said software program to a remote server.

10. A method according to claim 9 wherein said remote server is operated by an entity selected from the group consisting essentially of a school, organization, business or individual.

11. A method according to claim 9 further comprising the step of integrating said information from said remote server into said calendar.

12. A method according to claim 9 further comprising the step of downloading a second series of pictures from said remote server, said second series of pictures replacing said first series of pictures in said slide show window in said software program.

13. A system for organizing personal events and appointments comprising:
a personal organizer software program, said program comprising a main menu screen, a calendar screen, an address book screen, and a phone book screen; and
a slide show window on each of said screens, said slide show window displaying a rotating set of pictures while a user navigates through the software program.

14. A system according to claim 13 wherein said personal organizer software program is packaged on a compact disc.

15. A system according to claim 14 wherein said compact disc can be placed in a greeting card.

16. A system according to claim 14 wherein said compact disc can be a promotional item.

17. A system according to claim 13 wherein said screens are adapted to receive and store information entered by a user.

18. A system according to claim 17 wherein said pictures are uploaded by said user.

19. A system according to claim 17 wherein said pictures are downloadable from a server.

20. A system according to claim 17 wherein said pictures are pre-packaged with said software program.

21. An apparatus for personal organization comprising:
a personal organization software program, said program comprising a main menu screen, a calendar screen, an address book screen, and a phone book screen, said program being packaged on a compact disc; and
a slide show window on each of said screens, said slide show window displaying a rotating set of pictures while a user navigates through the software program.

22. A method for being notified about local events comprising:
initializing a personal organizer software program to correspond to a plurality of individual users, said organizer having a plurality of screens through which each of said users can navigate, each of said screens having a slide show window;
presenting a series of selected pictures for a preselected time period on each of said screens of said software program, said pictures appearing in said slide show window, said pictures appearing independently of the screen said user is viewing; and,
arranging a calendar provided by said software program, said calendar holding personal appointments, events and affairs of each of said users separately, said software program being adapted to receive information about local events from a server.

23. A method for concurrently organizing personal affairs and being notified about local events comprising:
initializing a personal organizer software program to correspond to a plurality of individual users, said organizer having a plurality of screens through which each of said users can navigate, each of said screens having a slide show window;
presenting a series of selected pictures for a preselected time period on each of said screens of said software program, said pictures appearing in said slide show window, said pictures appearing independently of the screen said user is viewing; and,
arranging a calendar provided by said software program, said calendar holding personal appointments, events and affairs of each of said users separately, said software program being adapted to receive information about local events from a server.
